(19) United States
(12) Patent Application Publication
(10) Pub. No.: US 2012/0242483 A1
(43) Pub. Date: Sep. 27, 2012

(54) EVACUATION INFORMATION SYSTEM AND METHOD THEREOF

(75) Inventors: CHE-MING KUO, Tu-Cheng (TW); JUNG-CHUNG TSAI, Tu-Cheng (TW); LI-CHUN WANG, Tu-Cheng (TW)

(73) Assignee: HON HAI PRECISION INDUSTRY CO., LTD., Tu-Cheng (TW)

(21) Appl. No.: 13/097,021

(22) Filed: Apr. 28, 2011

(30) Foreign Application Priority Data
Mar. 24, 2011 (CN) 201110071962.2

(51) Int. Cl. G08B 1/08

(52) U.S. Cl. 340/539.13

(57) ABSTRACT

The disclosure provides an evacuation information system and an evacuation information method adapted for the system. The system includes a fire detector, a system control center, a plurality of alarm information transmitters, and a mobile communication device. Each alarm information transmitter stores an electronic evacuation plan of a floor in a building, which marks evacuation routes. When the fire detector detects the presence of a fire, the mobile communication device on the same floor as the fire calculates the coordinates of the mobile communication device to confirm the position on the plan, and displays the plan and an optimal evacuation route. The mobile communication device on a different floor as the fire area displays the plan of the floor and a plurality of evacuation routes.

### BACKGROUND

1. Technical Field

The disclosure relates to an evacuation information system and, more particularly, to an evacuation information system and an evacuation information method adapted for the evacuation information system.

2. Description of Related Art

When a fire takes place in a multi-story building, such as an office building, a factory, or an apartment building, a fire alarm system will output a warning signal so that people can quickly evacuate from the fire area. However, people are unable to know the exact area of the fire, and there is no certain evacuation route. Therefore, some people cannot evacuate from the area in time if they are unfamiliar with the environment, consequently, the best evacuation information opportunity can be easily missed and can result in unnecessary casualties.

Therefore, what is needed is an evacuation information system to overcome the described shortcoming.

### BRIEF DESCRIPTION OF THE DRAWINGS

FIG. 1 is a block diagram of an evacuation information system in accordance with an exemplary embodiment.

FIG. 2 is a flowchart of an evacuation information method adapted for the system of FIG. 1, in accordance with an exemplary embodiment.

### DETAILED DESCRIPTION

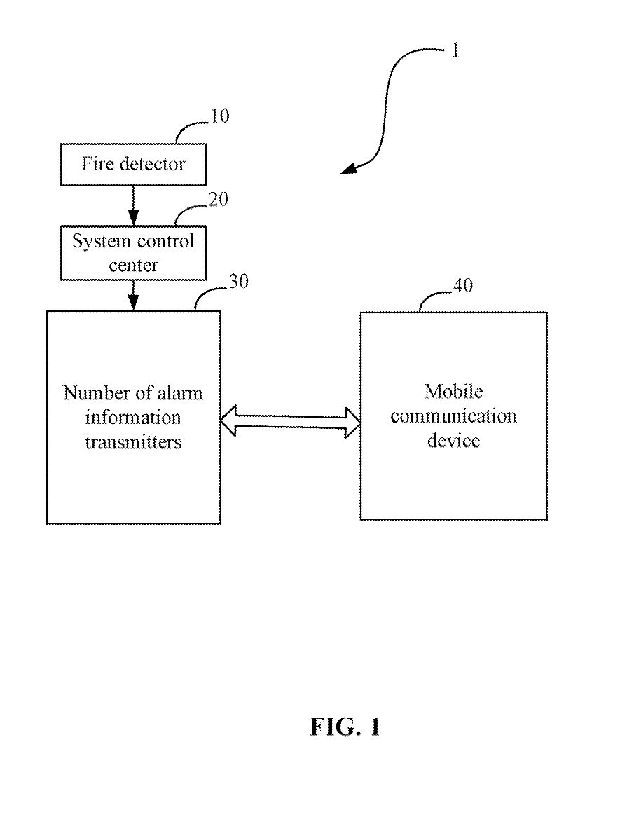

FIG. 1 is a block diagram of an evacuation information system in accordance with an exemplary embodiment. The evacuation information system 1 is utilized for a multi-story building. The evacuation information system 1 includes a fire detector 10, a system control center 20, a plurality of alarm information transmitters 30, and a mobile communication device 40. In the embodiment, the fire detector 10 and the alarm information transmitters 30 are connected to the system control center 20 with a wire. The mobile communication device 40 broadcasts the alarm information transmitters 30 in a predetermined area with a wireless signal.

The fire detector 10 is configured for detecting the presence of a fire in an area. The system control center 20 is configured for transmitting fire position information to all alarm information transmitters 30 in the building when the fire detector 10 detects the presence of the fire. For example, when the fire detector 10 from an office on a floor detects a fire, the system control center 20 transmits that the position of the fire is the office on the floor to all alarm information transmitters 30. In the embodiment, the fire detector 10 is a smoke detector. The smoke detector 10 detects the presence of smoke in an area and evaluates that a fire is occurring when the thickness of the smoke reaches a preset value. In another embodiment, each floor is equipped with a plurality of fire detectors 10 in appropriated positions, each fire detector 10 is assigned an ID, and the system control center 20 distinguishes the area that is on fire according to the ID of the fire detector 10.

Each alarm information transmitter 30 stores an electronic evacuation plan of a floor which marks a plurality of evacuation routes. For example, when an alarm information transmitter 30 is on the third floor, the alarm information transmitter 30 on the third floor stores an electronic evacuation plan of the third floor. Therefore, the alarm information transmitters 30 on the same floor store the same electronic evacuation plan. All the alarm information transmitters 30 in the building generate a warning signal to broadcast the fire position information when the fire position information is received from the system control center 20.

Each alarm information transmitter 30 further evaluates whether it is on the same floor as the fire according to the fire position information. When the alarm information transmitter 30 and the fire are on the same floor, the alarm information transmitter 30 is configured for acquiring the coordinates of the alarm information transmitter 30 and sending a wireless signal including a position content, the position content includes the coordinates of the alarm information transmitter 30 and the electronic evacuation plan of the fire floor.

The mobile communication device 40 on the fire floor is configured for receiving the wireless signal including the position content from each alarm information transmitter 30 on the floor of the fire, storing the electronic evacuation plan, and obtaining a distance from each alarm information transmitter 30 according to an attenuation situation of the wireless signal. Then, calculating the coordinates of the mobile communication device according to the distances and the coordinates of the alarm information transmitters 30 on the floor of the fire, and displaying the position and an optimal evacuation route on the electronic evacuation plan according to the coordinates of the mobile communication device. Therefore, a mobile communication device user may quickly evacuate from the fire according to the optimal evacuation route on the electronic evacuation plan displayed on a screen.

When the mobile communication device 40 is close to the alarm information transmitter 30 on the floor of the fire, the mobile communication device 40 receives a wireless signal with a strong signal strength. When a distance between the mobile communication device 40 and the alarm information transmitter 30 is out of the range of the predetermined area, the mobile communication device 40 cannot receive the wireless signal from the alarm information transmitter 30.

The mobile communication device 40 calculates the coordinates (x, y, z) by the formula: (xₙ−x)²+(yₙ−y)²+(zₙ−z)²=(Dₙ)², wherein (xₙ, yₙ, zₙ) represents the coordinates of the nth alarm information transmitter 30 and Dₙ represents a distance between the nth alarm information transmitter 30 and the mobile communication device 40. Therefore, when the mobile communication device 40 receives n wireless signals from the n alarm information transmitters 30, the mobile communication device 40 calculates the coordinates according to n formulas. For example, the mobile communication device 40 receives three wireless signals including the position content from three alarm information transmitters 30 in the predetermined area on the floor of the fire, acquires three coordinates of the three alarm information transmitters 30 that are (x1, y1, z1), (x2, y2, z2), and (x3, y3, z3). The mobile communication device 40 calculates the three distances (D1, D2, D3) between the mobile communication device 40 and the three alarm information transmitters 30. The three formulas include (x1−x)²+(y1−y)²+(z1−z)²=(D1)², (x2−x)²+(y2−y)²+(z2−z)²(D2)², (x3−x)²+(y3−y)²+(z3−z)²=(D3)², (x2−x)²+(y2−y)²+(z2−z)²═(D2)², (x3−x)²+(y3−y)²+(z3−z)²═(D3)², therefore, obtaining the coordinates (x, y, z) of the mobile communication device 40.

When the alarm information transmitters 30 are on different floors as the fire, each alarm information transmitter 30 on the different floor further sends a wireless signal including an electronic evacuation plan of the different floor to the mobile communication device 40 on the different floor and the mobile communication device 40 further displays the electronic evacuation plan and a plurality of evacuation routes. Therefore, a mobile communication device user on the different floor as the fire may select one acceptable evacuation route to escape.

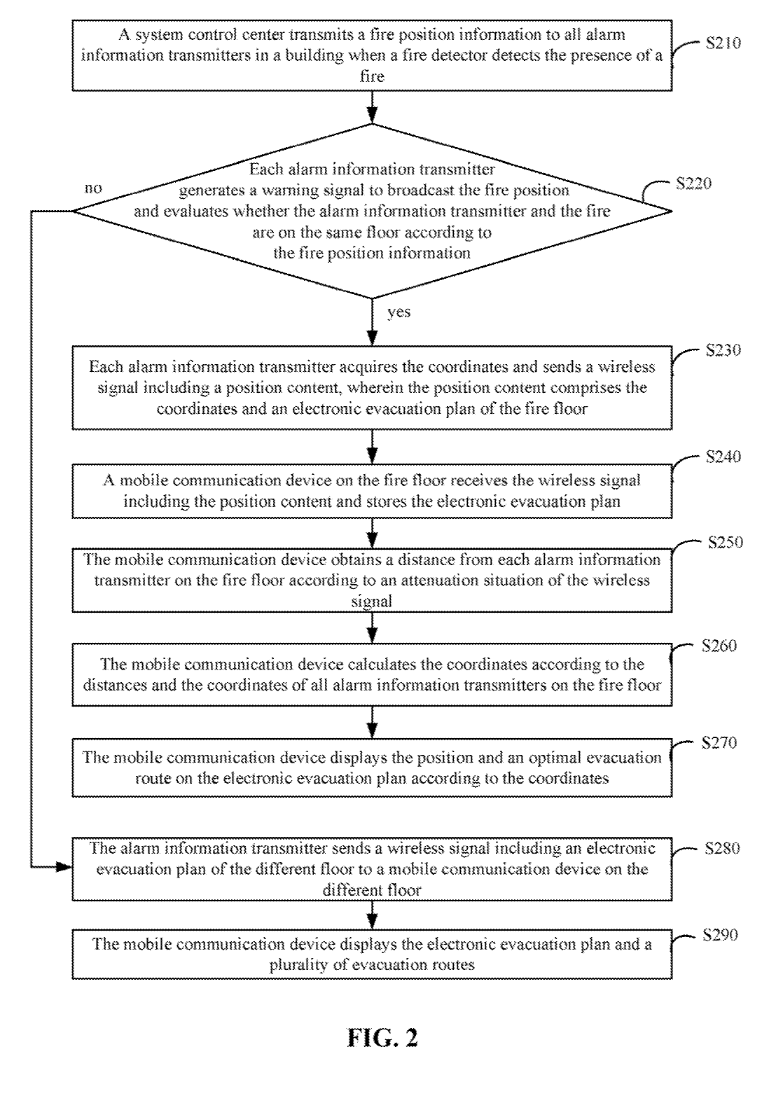

FIG. 2 is a flowchart of an evacuation information method adapted for the system of FIG. 1. In step S210, the system control center 20 transmits the fire position information to all alarm information transmitters 30 in the building when the fire detector 10 detects the presence of a fire.

In step S220, each alarm information transmitter 30 generates the warning signal to broadcast the fire position information and evaluates whether the alarm information transmitter 30 and the fire are on the same floor according to the fire position information when the fire position information is received from the system control center 20.

If some alarm information transmitters 30 are on the same floor as the fire, in step S230, each alarm information transmitter 30 acquires the coordinates of the alarm information transmitter 30 and sends the wireless signal including the position content, wherein the position content includes the coordinates of the alarm information transmitter 30 and the electronic evacuation plan of the fire floor.

In step S240, the mobile communication device 40 on the fire floor receives the wireless signal including the position content and stores the electronic evacuation plan of the fire floor.

In step S250, the mobile communication device 40 obtains the distance from each alarm information transmitter 30 in the fire area according to an attenuation situation of the wireless signal.

In step S260, the mobile communication device 40 further calculates the coordinates of the mobile communication device 40 according to the distances and the coordinates of all alarm information transmitters 30 in the fire area.

In step S270, the mobile communication device 40 displays the position and an optimal evacuation route on the electronic evacuation plan according to the coordinates of the mobile communication device 40.

If one alarm information transmitter 30 is on a different floor as the fire, in step S280, the alarm information transmitter 30 sends the wireless signal including an electronic evacuation plan of the different floor to the mobile communication device 40 on the different floor.

In step S290, the mobile communication device 40 displays the electronic evacuation plan of the different floor and a plurality of evacuation routes on the electronic evacuation plan.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An evacuation information system, comprising:
a fire detector for detecting the presence of a fire in a building;
a system control center, connected to the fire detector, for transmitting fire position information when the fire detector detects the presence of the fire;
a plurality of alarm information transmitters on a same floor in the building to receive the fire position information, each one to store an electronic evacuation plan of the floor which marks a plurality of evacuation routes, the alarm information transmitters being configured for evaluating whether the alarm information transmitters and the fire are on the same floor according to the fire position information, each one of the plurality of alarm information transmitters to acquire the coordinates of the alarm information transmitter and send a wireless signal including a position content of the alarm information transmitter when the alarm information transmitters and the fire are on the same floor, wherein the position content comprises the coordinates of each alarm information transmitter and the electronic evacuation plan of the fire floor; and
a mobile communication device on the same floor of the fire, to receive the wireless signal from each alarm information transmitter including the position content, store the electronic evacuation plan, obtain a distance from each alarm information transmitter according to an attenuation situation of the wireless signal, calculate the coordinates of the mobile communication device according to the distances and the coordinates of the alarm information transmitters on the same floor, and display the position and an optimal evacuation route according to the electronic evacuation plan and the coordinates of the mobile communication device.

2. The evacuation information system as recited in claim 1, wherein the fire detector is a smoke detector.

3. The evacuation information system as recited in claim 1, wherein all the alarm information transmitters in the building are further generating a warning signal to broadcast the fire position information when the fire position information is received from the system control center.

4. The evacuation information system as recited in claim 1, wherein the mobile communication device calculates the coordinates (x, y, z) of the mobile communication device by the formula: (xₙ−x)²+(yₙ−y)²+(zₙ−z)²=(Dₙ)², wherein (xₙ, yₙ, zₙ) represents the coordinates of the nth alarm information transmitter and Dₙ represents a distance between the nth alarm information transmitter and the mobile communication device.

5. The evacuation information system as recited in claim 1, wherein when the alarm information transmitters are on a different floor as the fire, each alarm information transmitter on the different floor is further for sending a wireless signal including an electronic evacuation plan of the different floor to the mobile communication device on the different floor and the mobile communication device is further displaying the electronic evacuation plan and a plurality of evacuation routes.

6. An evacuation information method adapted for an evacuation information system, wherein the evacuation information system comprises a fire detector for detecting the presence of a fire, a system control center, a plurality of alarm information transmitters, and a mobile communication device, and each alarm information transmitter stores an electronic evacuation plan which marks a plurality of evacuation routes, the method comprising:
the system control center transmitting fire position information to all alarm information transmitters in a building when the fire detector detects the presence of a fire;
each alarm information transmitter evaluating whether the alarm information transmitter and the fire are on the same floor according to the fire position information;
if some alarm information transmitters are on the same floor as the fire, each one of some alarm information transmitters acquiring the coordinates of the alarm information transmitter and sending a wireless signal including a position content, wherein the position content comprises the coordinates of the alarm information transmitter and the electronic evacuation plan of the fire floor;
the mobile communication device on the fire floor receiving the wireless signal including the position content and storing the electronic evacuation plan;
the mobile communication device obtaining a distance from each alarm information transmitter on the fire floor according to an attenuation situation of the wireless signal;
the mobile communication device calculating the coordinates of the mobile communication device according to the distances and the coordinates of all alarm information transmitters on the fire floor; and
the mobile communication device displaying the position and an optimal evacuation route on the electronic evacuation plan according to the coordinates of the mobile communication device.

7. The evacuation information method adapted for an evacuation information system as recited in claim 6, wherein the fire detector is a smoke detector.

8. The evacuation information method adapted for an evacuation information system as recited in claim 6, further comprising:
all alarm information transmitters in the building generating a warning signal to broadcast the fire position information when the fire position information is received from the system control center.

9. The evacuation information method adapted for an evacuation information system as recited in claim 6, wherein the mobile communication device calculates the coordinates (x, y, z) of the mobile communication device by the formula: (xₙ−x)²+(yₙ−y)²+(zₙ−z)²=(Dₙ)², wherein (xₙ, yₙ, zₙ) represents the coordinates of the nth alarm information transmitter and Dₙ represents a distance between the nth alarm information transmitter and the mobile communication device.

10. The evacuation information method adapted for an evacuation information system as recited in claim 6, further comprising:
if one alarm information transmitter is on a different floor as the fire, the alarm information transmitter sending a wireless signal including an electronic evacuation plan of the different floor to the mobile communication device on the different floor; and
the mobile communication device displaying the electronic evacuation plan and a plurality of evacuation routes.
